(19) United States
(12) Patent Application Publication
(10) Pub. No.: US 2026/0056630 A1
(43) Pub. Date: Feb. 26, 2026

(54) MOTHER SUBSTRATE FOR SENSOR

(71) Applicant: Samsung Display Co., Ltd., Yongin-si (KR)

(72) Inventors: Sung-Jin YANG, Yongin-si (KR); Hyunsik PARK, Yongin-si (KR); Minchan LEE, Yongin-si (KR)

(21) Appl. No.: 19/257,354

(22) Filed: Jul. 1, 2025

(30) Foreign Application Priority Data
Aug. 22, 2024 (KR) 10-2024-0112955

(51) Int. Cl. G06F 3/041; G06F 3/044

(52) U.S. Cl. CPC G06F 3/04164; G06F 3/0446

(57) ABSTRACT

Disclosed is a mother substrate for a sensor, the mother substrate including a base substrate, and a sensor substrate above the base substrate, and including a main part including a sensing area, a non-sensing area surrounding the sensing area in plan view, a sensing electrode in the sensing area, and a trace line in the non-sensing area, and electrically connected with the sensing electrode, and a peripheral part surrounding the main part in plan view, and including an inspection line spaced apart from the trace line and having a same shape as the trace line.

### CROSS-REFERENCE TO RELATED APPLICATIONS

The present application claims priority to, and the benefit of, Korean Patent Application No. 10-2024-0112955 filed on Aug. 22, 2024, in the Korean Intellectual Property Office, the disclosures of which are incorporated by reference herein in their entireties.

### BACKGROUND

Embodiments of the present disclosure described herein relate to a mother substrate for a sensor that inspects an input sensor for a defect using a peripheral part.

Various display devices used in multimedia devices, such as a television, a mobile phone, a tablet computer, a car navigation unit, a game machine, and the like, are being developed. The display devices include a keyboard or a mouse as an input device. In addition, the display devices include an input sensor, such as a touch panel, as an input device.

Meanwhile, for convenience of process, the input sensor may be formed by forming a sensor substrate on glass and separating the sensor substrate into individual input sensors using a cutting device. Automated optical inspection may be used to examine whether the wiring included in the input sensor is defective, but it may be difficult to detect defects in the trace lines included in the input sensor.

### SUMMARY

Embodiments of the present disclosure provide a reliable input sensor including, on a peripheral part of a mother substrate for a sensor, an inspection line for detecting whether a trace line of the input sensor is defective.

According to one or more embodiments, a mother substrate for a sensor includes a base substrate, and a sensor substrate above the base substrate, and including a main part including a sensing area, a non-sensing area surrounding the sensing area in plan view, a sensing electrode in the sensing area, and a trace line in the non-sensing area, and electrically connected with the sensing electrode, and a peripheral part surrounding the main part in plan view, and including an inspection line spaced apart from the trace line and having a same shape as the trace line.

The inspection line may include a first sub-inspection line spaced apart from the trace line in a first direction, and a second sub-inspection line spaced apart from the first sub-inspection line in the first direction.

A distance between the trace line and the first sub-inspection line may be substantially equal to a distance between the first sub-inspection line and the second sub-inspection line.

The trace line may include a first trace line connected to one end of the sensing electrode, and a second trace line connected to an opposite end of the sensing electrode that is opposite the one end of the sensing electrode.

The inspection line may include a first inspection line spaced apart from the first trace line in a first direction, and a second inspection line spaced apart from the second trace line in a direction opposite to the first direction.

The main part may further include a first main part and a second main part aligned in the first direction, wherein a virtual line crossing a center between the first main part and the second main part is defined between the first main part and the second main part.

The first inspection line corresponding to the first trace line in the first main part, and the second inspection line corresponding to the second trace line in the second main part, may have symmetrical shapes with respect to the virtual line.

The main part may have a quadrangular shape including first to fourth surfaces, wherein the inspection line includes first to fourth inspection lines respectively corresponding to the first to fourth surfaces.

The peripheral part may further include a connecting line electrically connecting the first to fourth inspection lines.

The connecting line may be configured to receive a ground voltage.

The sensor substrate may further include a cutting line for dividing the main part from the peripheral part.

The cutting line may be between the trace line and the inspection line.

The cutting line may include a metal layer, and an insulating layer above the metal layer.

The trace line and the inspection line may include a first metal layer, and a second metal layer above the first metal layer.

The trace line and the inspection line may further include an anti-oxidation film between the first metal layer and the second metal layer.

According to one or more embodiments, a mother substrate for a sensor includes a base substrate, and a sensor substrate above the base substrate, and including a main part including a sensing area, a non-sensing area configured to surround the sensing area, and a signal line in the non-sensing area, and a peripheral part surrounding the main part in plan view, and including an inspection line spaced apart from the signal line, having a same shape as the signal line, and including a first sub-inspection line spaced apart from the signal line by a first distance, and a second sub-inspection line spaced apart from the first sub-inspection line by the first distance in a direction opposite to a direction in which the signal line is located.

The main part may further include a sensing electrode in the sensing area, wherein the signal line includes a first signal line connected to one end of the sensing electrode, and a second signal line connected to an opposite end of the sensing electrode that is opposite the one end of the sensing electrode.

The first sub-inspection line and the second sub-inspection line may correspond to the first signal line, wherein the inspection line further includes a third sub-inspection line spaced apart from the second signal line by the first distance, and a fourth sub-inspection line spaced apart from the third sub-inspection line by the first distance in a direction opposite to a direction in which the second signal line is located.

The main part may further include a first main part and a second main part that are aligned, wherein a virtual line crossing a center between the first main part and the second main part is defined between the first main part and the second main part.

The first sub-inspection line corresponding to the first signal line in the first main part, and the third sub-inspection line corresponding to the second signal line in the second main part, may have symmetrical shapes with respect to the virtual line, wherein the second sub-inspection line corresponding to the first signal line in the first main part, and the fourth sub-inspection line corresponding to the second signal line in the second main part, have symmetrical shapes with respect to the line.

### BRIEF DESCRIPTION OF THE DRAWINGS

The above and other aspects of the present disclosure will become apparent by describing in detail embodiments thereof with reference to the accompanying drawings.

FIG. 1 is a plan view of a mother substrate for a sensor according to one or more embodiments of the present disclosure.

FIG. 2 is a plan view of a main part of the present disclosure.

FIG. 3A is a plan view of a fourth area AA4′ of FIG. 2.

FIG. 3B is a sectional view of the main part taken along the line I-I′ of FIG. 3A according to one or more embodiments of the present disclosure.

FIG. 4A is a plan view of a first area AA1′ of FIG. 1.

FIG. 4B is a plan view illustrating one or more embodiments of the first area AA1′ of FIG. 1.

FIGS. 5A and 5B are sectional views taken along the line II-II′ of FIG. 4A.

FIG. 6 is a plan view of a second area AA2′ of FIG. 1.

FIG. 7 is a plan view of a third area AA3′ of FIG. 1.

FIG. 8 is a plan view of a mother substrate for a sensor according to one or more embodiments of the present disclosure.

FIG. 9A is a perspective view of an electronic device according to one or more embodiments of the present disclosure.

FIG. 9B is an exploded perspective view of the electronic device illustrated in FIG. 9A according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

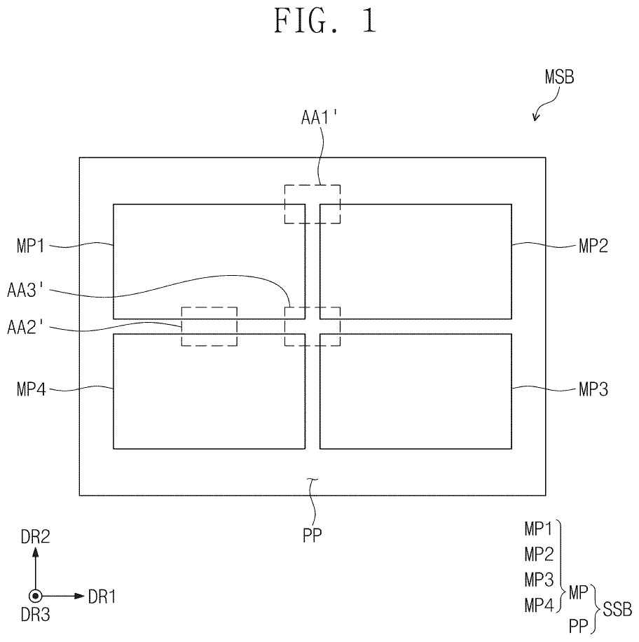

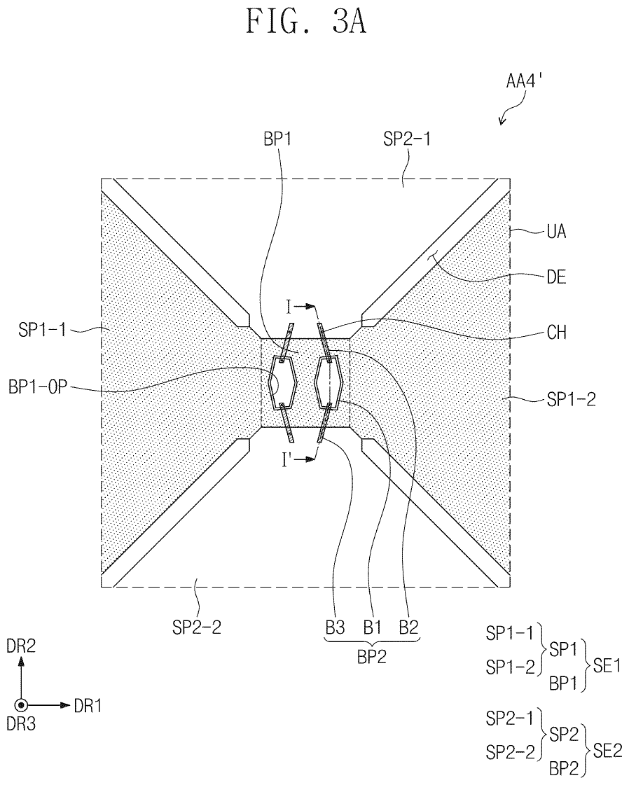

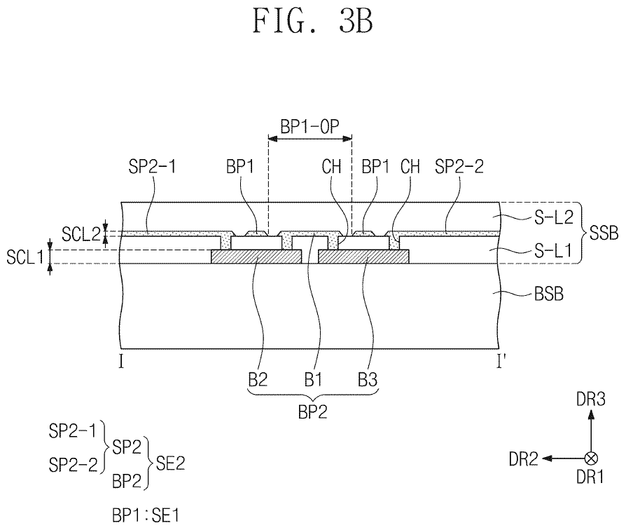

FIG. 1 is a plan view of a mother substrate for a sensor according to one or more embodiments of the present disclosure. Hereinafter, for convenience of description, the mother substrate MSB for the sensor of the present disclosure will be referred to as the mother substrate MSB. The mother substrate MSB may include a base substrate BSB (refer to FIG. 3B), and a sensor substrate SSB located on the base substrate BSB (as used herein, “located on” may mean “above”). In FIG. 1, only the sensor substrate SSB is illustrated.

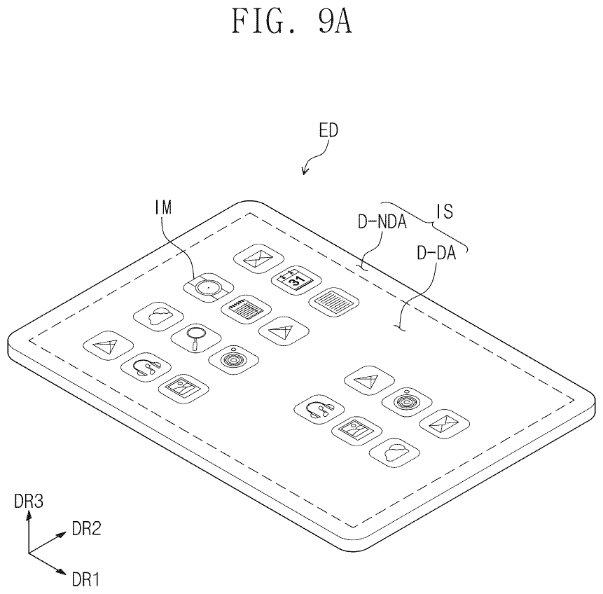

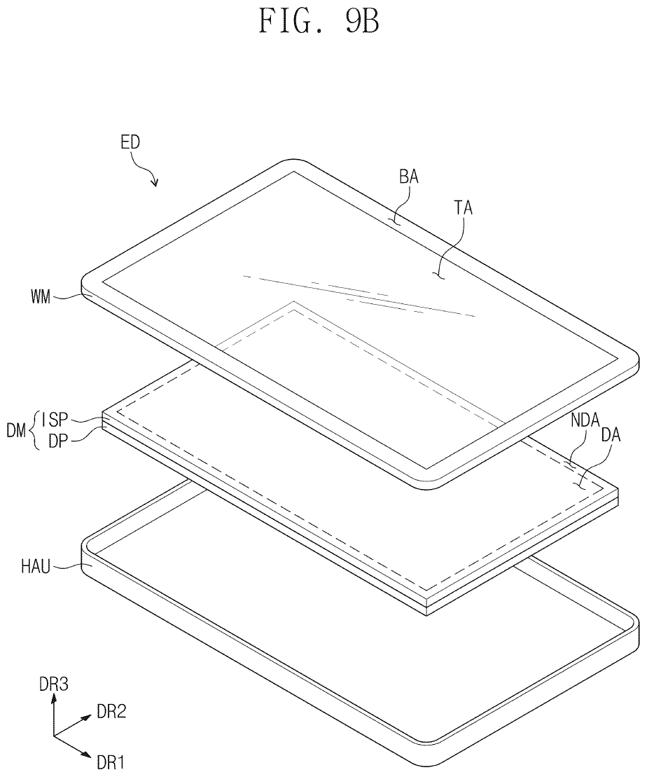

Referring to FIG. 1, the sensor substrate SSB may include a main part MP, and a peripheral part PP surrounding the main part MP (e.g., in plan view). A part corresponding to the main part MP of the sensor substrate SSB may correspond to an input sensor ISP of a display module DM illustrated in FIG. 9B.

According to one or more embodiments of the present disclosure, the main part MP may include a plurality of main parts. For example, the main part MP may include first to fourth main parts MP1, MP2, MP3, and MP4. The first to fourth main parts MP1, MP2, MP3, and MP4 may be arranged in the clockwise direction with respect to the first main part MP1. In FIG. 1, the first to fourth main parts MP1, MP2, MP3, and MP4 are illustrated as having the same shape and size. However, the present disclosure is not limited thereto. For example, the first to fourth main parts MP1, MP2, MP3, and MP4 may have different shapes and sizes.

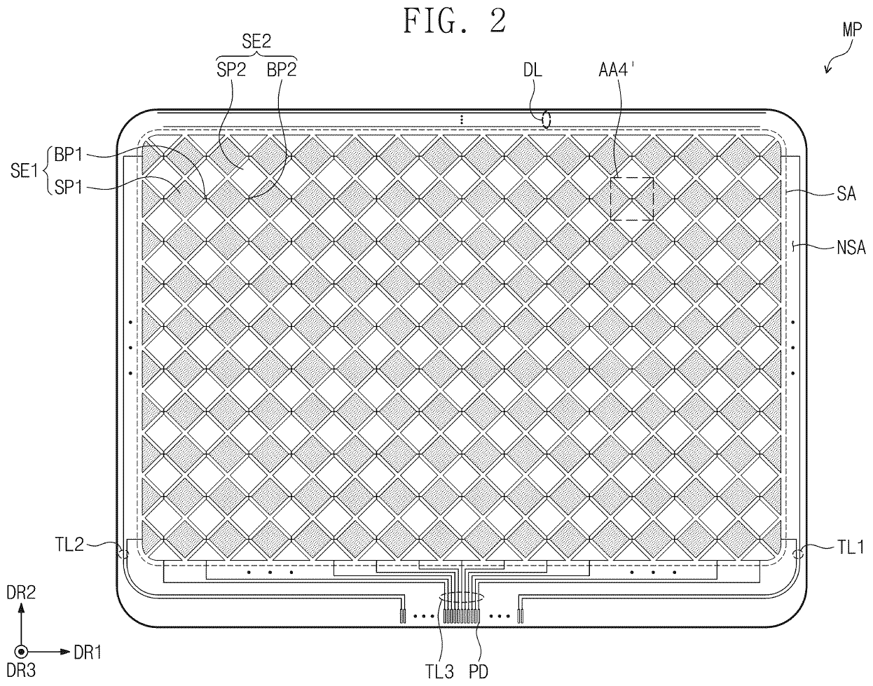

FIG. 2 is a plan view of the main part of the present disclosure. The main part MP may be one of the first to fourth main parts MP1, MP2, MP3, and MP4 illustrated in FIG. 1. That is, description of the main part MP may be identically applied to the first to fourth main parts MP1, MP2, MP3, and MP4.

Referring to FIG. 2, the main part MP may include a sensing area SA, and a non-sensing area NSA surrounding the sensing area SA (in plan view). The sensing area SA may be an area activated in response to an electrical signal.

The main part MP may include a plurality of sensing electrodes SE1 and SE2, and a plurality of trace lines TL1, TL2, and TL3 connected to the plurality of sensing electrodes SE1 and SE2. The sensing electrodes SE1 and SE2 are located in the sensing area SA. The sensing electrodes SE1 and SE2 may include the plurality of first sensing electrodes SE1 and the plurality of second sensing electrodes SE2 crossing each other.

The first sensing electrodes SE1 may extend in a first direction DR1, and may be arranged in a second direction DR2. Each of the first sensing electrodes SE1 may include a plurality of sensing parts SP1 (hereinafter, referred to as the first group of sensing parts) and a plurality of intermediate parts BP1 (hereinafter, referred to as the first group of intermediate parts) arranged in the first direction DR1.

The second sensing electrodes SE2 may extend in the second direction DR2, and may be arranged in the first direction DR1. Each of the second sensing electrodes SE2 may include a plurality of sensing parts SP2 (hereinafter, referred to as the second group of sensing parts) and a plurality of intermediate parts BP2 (hereinafter, referred to as the second group of intermediate parts) arranged in the second direction DR2.

The terms “first sensing electrodes SE1 and second sensing electrodes SE2” used herein are only terms defined to distinguish the two types of electrodes, and do not have special meanings. In one or more embodiments of the present disclosure, the electrodes extending in the first direction DR1 may be defined as the second sensing electrodes, and the electrodes extending in the second direction DR2 may be defined as the first sensing electrodes. In one or more embodiments of the present disclosure, the main part MP may include only one type of sensing electrodes. The main part MP may sense an external input in a self-cap type.

The trace lines TL1, TL2, and TL3 are located in the non-sensing area NSA. The trace lines TL1, TL2, and TL3 may include the plurality of first trace lines TL1, the plurality of second trace lines TL2, and the plurality of third trace lines TL3. The terms “first trace lines TL1,” “second trace lines TL2,” and “third trace lines TL3” are only terms defined to distinguish the three types of trace lines, and do not have special meanings. The trace lines may be referred to as signal lines. Pads PD are connected to ends of the trace lines TL1, TL2, and TL3, respectively. As illustrated in FIG. 2, the pads PD may be aligned in the first direction DR1.

The first trace lines TL1 are electrically connected to first ends of the first sensing electrodes SE1, respectively. The second trace lines TL2 are electrically connected to second ends (e.g., opposite ends) of the first sensing electrodes SE1, respectively. The third trace lines TL3 are electrically connected to first ends of the second sensing electrodes SE2, respectively. As will be described below, each of the trace lines TL1, TL2, and TL3 may be located at a layer that is different from the layer at which a corresponding sensing electrode SE1 or SE2 is located. The expression “the trace lines are electrically connected to the corresponding sensing electrodes,” as used herein, may mean that the trace lines and the corresponding sensing electrodes are integrally formed or brought into contact with each other through contact holes penetrating an insulating layer.

The connection relationship between the sensing electrodes SE1 and SE2 and the trace lines TL1, TL2, and TL3 is not limited to the above description. According to one or more embodiments of the present disclosure, the first trace lines TL1 may be omitted, or the second trace lines TL2 may be omitted. According to one or more embodiments of the present disclosure, the main part MP may further include trace lines connected to second ends of the second sensing electrodes SE2, respectively. In this case, either the first trace lines TL1 or the third trace lines TL3 may be omitted.

The main part MP of the present disclosure may further include dummy lines DL located in the area corresponding to the second ends of the second sensing electrodes SE2. The dummy lines DL might not be electrically connected with the second sensing electrodes SE2. The dummy lines DL may extend in the first direction DR1, and may be arranged in the second direction DR2. The dummy lines DL may include the same configuration as the trace lines TL1, TL2, and TL3. The dummy lines DL may be electrically isolated floating patterns. In one or more embodiments of the present disclosure, the dummy lines DL may be omitted.

The first sensing electrodes SE1 may receive drive signals through the first trace lines TL1 and the second trace lines TL2 (hereinafter, referred to as the RX electrode function). In one or more embodiments, a sensor drive circuit may receive detection signals through the third trace lines TL3 (hereinafter, referred to as the TX electrode function). The sensor drive circuit may measure the amount of change in mutual capacitance between the first sensing electrodes SE1 and the second sensing electrodes SE2 through the detection signals. However, without being limited thereto, the RX electrode function of the first sensing electrodes SE1 and the TX electrode function of the second sensing electrodes SE2 may be interchanged. For example, in one or more embodiments of the present disclosure, the third trace lines TL3 may receive the drive signals, respectively.

FIG. 3A is a plan view of a fourth area AA4′ of FIG. 2. FIG. 3B is a sectional view of the main part taken along the line I-I′ of FIG. 3A according to one or more embodiments of the present disclosure.

As illustrated in FIGS. 3A and 3B, the fourth area AA4′ corresponds to one unit area UA. The sensing area SA of FIG. 2 may include a plurality of unit areas UA of FIGS. 3A and 3B. An intersection area, or crossing region, of a first sensing electrode SE1 and a second sensing electrode SE2 is located in each unit area UA.

One of the first sensing electrode SE1 and the second sensing electrode SE2 may have a one-body shape (e.g., an integrated shape), and the other may include a plurality of patterns spaced apart from each other. The first sensing electrode SE1 having a one-body shape is illustrated as an example. Among the first group of sensing parts and intermediate parts and the second group of sensing parts and intermediate parts described with reference to FIG. 2, a group that has an integral, one-body shape will be described as sensing parts and intermediate parts, and a group that does not have a one-body shape will be described as sensing patterns and bridges.

Referring to FIG. 3A, the second sensing electrode SE2 may include the plurality of sensing patterns SP2 and the bridges BP2, each bridge BP2 being located between adjacent sensing patterns SP2 to electrically connect the adjacent sensing patterns SP2. One of two adjacent sensing patterns may be defined as a first sensing pattern SP2-1, and the other may be defined as a second sensing pattern SP2-2. The first sensing pattern SP2-1 and the second sensing pattern SP2-2 are spaced apart from each other in the second direction DR2.

The first sensing electrode SE1 may include the plurality of sensing parts SP1 and the intermediate parts BP1, each intermediate part BP1 being located between adjacent sensing parts SP1 to electrically connect the adjacent sensing parts SP1. One of two adjacent sensing parts SP1 may be defined as a first sensing part SP1-1, and the other may be defined as a second sensing part SP1-2. The intermediate part BP1 is located between the first sensing part SP1-1 and the second sensing part SP1-2 in the first direction DR1. Because the first sensing part SP1-1, the second sensing part SP1-2, and the intermediate part BP1 have a one-body shape, the boundaries are not distinguished. A portion of the first sensing electrode SE1 located between the first sensing pattern SP2-1 and the second sensing pattern SP2-2 in the second direction DR2 may be defined as the intermediate part BP1. The boundaries between the first and second sensing parts SP1-1 and SP1-2 and the intermediate part BP1 are illustrated by dotted lines in FIG. 3A.

Two bridges BP2 are illustrated in FIG. 3A. However, the number of bridges BP2 in the unit area UA is not particularly limited. Each of the bridges BP2 may include a first bridge pattern B1, a second bridge pattern B2, and a third bridge pattern B3. Each of the first bridge pattern B1, the second bridge pattern B2, and the third bridge pattern B3 may be a conductive pattern. The first bridge pattern B1 is located at a layer that is different from the layer at which the second bridge pattern B2 and the third bridge pattern B3 are located. The first bridge pattern B1 may be located at the same layer as the sensing pattern SP2. The first bridge pattern B1, when viewed from above the plane/in plan view, is located in an opening BP1-OP defined in the intermediate part BP1 of the first sensing electrode SE1.

The configuration of the bridge BP2 is not limited thereto. In one or more embodiments of the present disclosure, the bridge BP2 may include only one of the second bridge pattern B2 and the third bridge pattern B3. The one bridge pattern may be located at a layer that is different from the layer at which the first sensing pattern SP2-1 and the second sensing pattern SP2-2 are located. The one bridge pattern may be directly connected to the first sensing pattern SP2-1 and the second sensing pattern SP2-2.

A dummy electrode DE may be located between the first sensing pattern SP2-1 and the first sensing part SP1-1, between the first sensing pattern SP2-1 and the second sensing part SP1-2, between the second sensing pattern SP2-2 and the first sensing part SP1-1, and between the second sensing pattern SP2-2 and the second sensing part SP1-2. The dummy electrode DE may be an electrically isolated floating pattern. In one or more embodiments of the present disclosure, the dummy electrode DE may be omitted.

In FIG. 3A, the boundaries between the first sensing pattern SP2-1, the second sensing pattern SP2-2, the first sensing part SP1-1, the second sensing part SP1-2, and the dummy electrode DE are illustrated only as boundary lines, and the boundaries are not illustrated in detail. Each of the boundary lines briefly illustrates that two adjacent components among the first sensing pattern SP2-1, the second sensing pattern SP2-2, the first sensing part SP1-1, the second sensing part SP1-2, and the dummy electrode DE are spaced apart from each other.

Referring to FIGS. 3A and 3B together, the mother substrate MSB (refer to FIG. 1) may include the base substrate BSB and the sensor substrate SSB. The sensor substrate SSB may include insulating layers S-L1 and S-L2, and conductive layers SCL1 and SCL2 respectively covered by the insulating layers S-L1 and S-L2.

The base substrate BSB may include a glass substrate or a synthetic resin film. The base substrate BSB may have a multi-layer structure. The base substrate BSB may include a thin glass substrate, a protective film located on the thin glass substrate, and an adhesive layer that couples the thin glass substrate and the protective film.

The second bridge pattern B2 and the third bridge pattern B3 are located on the base substrate BSB. The conductive layer between the base substrate BSB and the first insulating layer S-L1 in the sensing area SA may be referred to as the first sensing conductive layer SCL1. For example, the second bridge pattern B2 and the third bridge pattern B3 may be the first sensing conductive layer SCL1. That is, the first sensing conductive layer SCL1 may include the second bridge pattern B2 and the third bridge pattern B3.

The second bridge pattern B2 and the third bridge pattern B3 may include a metal. The second bridge pattern B2 and the third bridge pattern B3 may include a single metal layer. The second bridge pattern B2 and the third bridge pattern B3 may include a molybdenum-niobium (MoNb) alloy. Because the second bridge pattern B2 and the third bridge pattern B3 may include the molybdenum-niobium (MoNb) alloy, the ohmic contact with the first sensing pattern SP2-1, the second sensing pattern SP2-2, and the first bridge pattern B1 brought into contact with each other through contact holes CH may be generally excellent/suitable. The second bridge pattern B2 and the third bridge pattern B3 may have a thickness of about 3500 Å to about 4500 Å.

The first insulating layer S-L1 may be located on the base substrate BSB. The first insulating layer S-L1 may cover the second bridge pattern B2 and the third bridge pattern B3. The first insulating layer S-L1 may cover the first sensing conductive layer SCL1. The first sensing pattern SP2-1 and the second sensing pattern SP2-2 are located on the first insulating layer S-L1. The intermediate part BP1 is located between the first sensing pattern SP2-1 and the second sensing pattern SP2-2 (e.g., in plan view). The first bridge pattern B1 is located in the opening BP1-OP of the intermediate part BP1.

The first sensing pattern SP2-1 and the first bridge pattern B1 contact the second bridge pattern B2 through contact holes CH penetrating the first insulating layer S-L1. The first bridge pattern B1 and the second sensing pattern SP2-2 contact the third bridge pattern B3 through contact holes CH penetrating the first insulating layer S-L1.

The conductive layer between the first insulating layer S-L1 and the second insulating layer S-L2 in the sensing area SA (refer to FIG. 2) may be referred to as the second sensing conductive layer SCL2. For example, the first sensing pattern SP2-1, the second sensing pattern SP2-2, the first sensing part SP1-1, the second sensing part SP1-2, the intermediate part BP1, and the first bridge pattern B1 may be referred to as the second sensing conductive layer SCL2.

The first sensing pattern SP2-1, the second sensing pattern SP2-2, the first sensing part SP1-1, the second sensing part SP1-2, the intermediate part BP1, and the first bridge pattern B1 may be formed through the same photolithography process and may include the same material. The first sensing pattern SP2-1, the second sensing pattern SP2-2, the first sensing part SP1-1, the second sensing part SP1-2, the intermediate part BP1, and the first bridge pattern B1 may include transparent conductive oxide (TCO). The first sensing pattern SP2-1, the second sensing pattern SP2-2, the first sensing part SP1-1, the second sensing part SP1-2, the intermediate part BP1, and the first bridge pattern B1 may include indium tin oxide (ITO), indium zinc oxide (IZO), zinc oxide (ZnO), or indium tin zinc oxide (ITZO). The first sensing pattern SP2-1, the second sensing pattern SP2-2, the first sensing part SP1-1, the second sensing part SP1-2, the intermediate part BP1, and the first bridge pattern B1 may have a thickness of about 800 Å to about 1300 Å. Because the first sensing pattern SP2-1, the second sensing pattern SP2-2, the first sensing part SP1-1, the second sensing part SP1-2, the intermediate part BP1, and the first bridge pattern B1 include the transparent conductive oxide, each of the sensing electrodes SE1 and SE2 of FIG. 2 may reduce or prevent a decrease in luminance even though overlapping light-emitting elements to be formed in a later process. In one or more embodiments of the present disclosure, the first sensing pattern SP2-1, the second sensing pattern SP2-2, the first sensing part SP1-1, the second sensing part SP1-2, the intermediate part BP1, and the first bridge pattern B1 may include PEDOT, a metal nano wire, or graphene.

The second insulating layer S-L2 may be located on the first insulating layer S-L1. The second insulating layer S-L2 may cover the second sensing conductive layer SCL2. The second insulating layer S-L2 may cover the first sensing pattern SP2-1, the second sensing pattern SP2-2, the intermediate part BP1, and the first bridge pattern B1. The second insulating layer S-L2 may cover the first sensing part SP1-1 and the second sensing part SP1-2. The first insulating layer S-L1 and the second insulating layer S-L2 may include an inorganic material or an organic material. The first insulating layer S-L1 and the second insulating layer S-L2 may include silicon oxide, silicon nitride, or silicon oxy nitride. The thickness of the first insulating layer S-L1 may range, for example, from about 4500 Å to about 5500 Å, and the thickness of the second insulating layer S-L2 may range, for example, from about 3500 Å to about 4500 Å. In one or more embodiments, an inorganic layer may be additionally located between the base substrate BSB and the second and third bridge patterns B2 and B3.

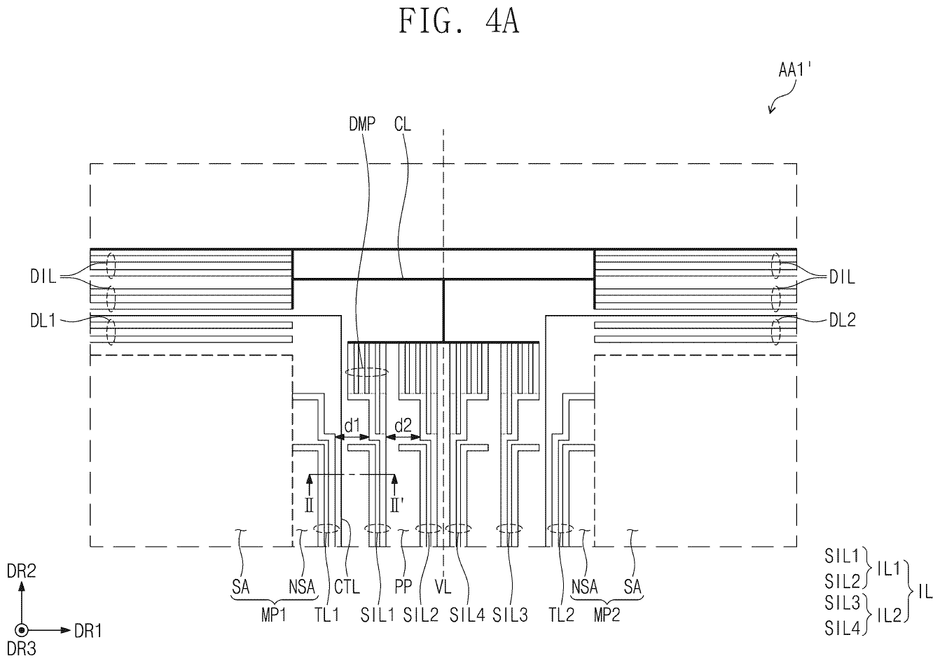

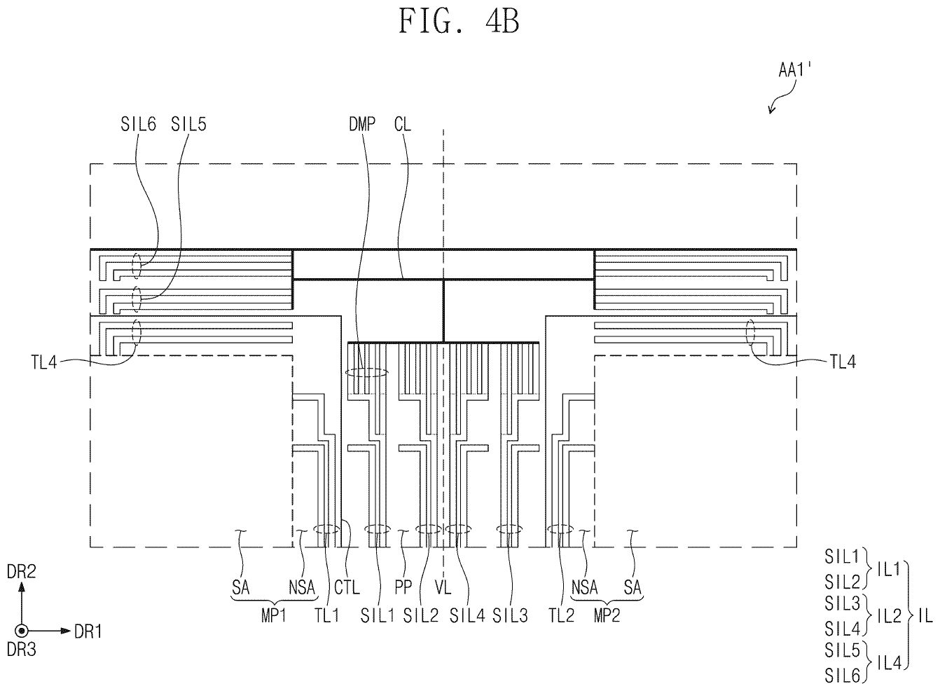

FIG. 4A is a plan view of a first area AA1′ of FIG. 1. FIG. 4B is a plan view illustrating one or more embodiments of the first area AA1′ of FIG. 1. Hereinafter, repetitive descriptions identical to ones given above will be omitted.

Referring to FIG. 4A, the peripheral part PP may include an inspection line IL for inspecting the trace lines TL1 and TL2 for defects (e.g., open circuits in the trace lines TL1 and TL2). The inspection line IL may include first inspection lines IL1 for inspecting the first trace lines TL1 included in the first main part MP1, and second inspection lines IL2 for inspecting the second trace lines TL2 included in the second main part MP2.

The first inspection lines IL1 may include first sub-inspection lines SIL1 spaced apart from the first trace lines TL1 in the first direction DR1, and second sub-inspection lines SIL2 spaced apart from the first sub-inspection lines SIL1 in the first direction DR1. According to one or more embodiments of the present disclosure, the shape of the first trace lines TL1 may be the same as the shapes of the first sub-inspection lines SIL1 and the second sub-inspection lines SIL2. That is, the shape of the first trace lines TL1 and the shape of the first sub-inspection lines SIL1 corresponding thereto may be the same as each other, and the shape of the first trace lines TL1 and the shape of the second sub-inspection lines SIL2 corresponding thereto may be the same as each other. Although two first trace lines TL1, two first sub-inspection lines SIL1, and two second sub-inspection lines SIL2 are illustrated in FIG. 4A, the numbers of first trace lines TL1, first sub-inspection lines SIL1, and second sub-inspection lines SIL2 may be three or more.

Although the first inspection lines IL1 of the present disclosure are illustrated as including the two sub-inspection lines SIL1 and SIL2, the present disclosure is not limited thereto, and the first inspection lines IL1 may include three or more sub-inspection lines having the same shape. In this case, the sum of the number of first inspection lines IL1 and the number of sub-inspection lines may be odd.

The gap (or, the minimum gap) between the first trace lines TL1 and the first sub-inspection lines SIL1 may be defined as a first distance (e.g., first gap) d1, and the gap between the first sub-inspection lines SIL1 and the second sub-inspection lines SIL2 may be defined as a second distance (e.g., second gap) d2. According to one or more embodiments of the present disclosure, the first distance d1 and the second distance d2 may be equal to each other. The first trace lines TL1 may be electrically isolated from the first inspection lines IL1, and the second sub-inspection lines SIL2 may be electrically isolated from the first sub-inspection lines SIL1.

The first trace lines TL1 may be inspected for defects through the first sub-inspection lines SIL1 and the second sub-inspection lines SIL2 of the present disclosure. For example, the first trace lines TL1 may be inspected for defects through automated optical inspection (AOI) together with the first sub-inspection lines SIL1 and the second sub-inspection lines SIL2. For example, an automated optical inspection device may take an image of the first trace lines TL1, the first sub-inspection lines SIL1, and the second sub-inspection lines SIL2, and may determine whether the first trace lines TL1, the first sub-inspection lines SIL1, and the second sub-inspection lines SIL2 have the same shape, based on the first sub-inspection lines SIL1. That is, whether the first trace lines TL1 are defective may be detected through the inspection. Thus, the reliability of an input sensor to be formed through the first main part MP1 may be improved.

The second inspection lines IL2 may include third sub-inspection lines SIL3 spaced apart from the second trace lines TL2 in the direction opposite to the first direction DR1, and fourth sub-inspection lines SIL4 spaced apart from the third sub-inspection lines SIL3 in the direction opposite to the first direction DR1. According to one or more embodiments of the present disclosure, the shape of the second trace lines TL2 may be the same as the shapes of the third sub-inspection lines SIL3 and the fourth sub-inspection lines SIL4. A width of the gap between the second trace lines TL2 and the third sub-inspection lines SIL3 may be substantially equal to a width of the gap between the third sub-inspection lines SIL3 and the fourth sub-inspection lines SIL4.

In the same way as the method of inspecting the first trace lines TL1 for defects, the second trace lines TL2 may be inspected for defects through the third sub-inspection lines SIL3 and the fourth sub-inspection lines SIL4.

According to one or more embodiments of the present disclosure, the first inspection lines IL1 and the second inspection lines IL2 may be symmetrical to each other with respect to a virtual line VL crossing the center (e.g., median) between the first main part MP1 and the second main part MP2. For example, the first sub-inspection lines SIL1 may be symmetrical to the third sub-inspection lines SIL3 with respect to the virtual line VL, and the second sub-inspection lines SIL2 may be symmetrical to the fourth sub-inspection lines SIL4 with respect to the virtual line VL. However, the present disclosure is not limited thereto. When the shape of the first trace lines TL1 and the shape of the second trace lines TL2 are different from each other, the first inspection lines IL1 and the second inspection lines IL2 may not be symmetrical to each other with respect to the virtual line VL.

The peripheral part PP of the present disclosure may further include dummy inspection lines DIL that correspond to first dummy lines DL1 included in the first main part MP1, and second dummy lines DL2 included in the second main part MP2. The dummy inspection lines DIL may have the same shape as the first dummy lines DL1 and the second dummy lines DL2. For example, the dummy inspection lines DIL may extend in the first direction DR1, and may be arranged in the second direction DR2.

The peripheral part PP of the present disclosure may further include a connecting line CL. The connecting line CL may be referred to as a short line. The connecting line CL may be electrically connected with the lines DIL and IL included in the peripheral part PP. For example, the connecting line CL may be electrically connected with the first to fourth sub-inspection lines SIL1, SIL2, SIL3, and SIL4, which are included in the inspection lines IL, and the dummy inspection lines DIL. The connecting line CL may be electrically connected with the first to fourth sub-inspection lines SIL1, SIL2, SIL3, and SIL4 through dummy patterns DMP located between the connecting line CL and the first to fourth sub-inspection lines SIL1, SIL2, SIL3, and SIL4. The dummy patterns DMP may extend from the first to fourth sub-inspection lines SIL1, SIL2, SIL3, and SIL4, respectively.

According to one or more embodiments of the present disclosure, a ground voltage may be applied to the connecting line CL. That is, the ground voltage may be applied to the lines CL, DIL, and IL included in the peripheral part PP. Because the connecting line CL is electrically connected with the lines DIL and IL included in the peripheral part PP to form an equipotential, the connecting line CL may reduce or prevent the likelihood of static electricity being formed between the lines CL, DIL, and IL included in the peripheral part PP, and may reduce or prevent the likelihood of the lines included in the main parts MP1 and MP2 being damaged by static electricity.

The peripheral part PP of the present disclosure may further include a cutting line CTL. The cutting line CTL may divide the main parts MP1 and MP2 from the peripheral part PP. In a later process, the mother substrate MSB illustrated in FIG. may be cut along the cutting line CTL so that the main parts MP1, MP2, MP3, and MP4 may be separated from the peripheral part PP.

Referring to FIG. 4B, each of the first main part MP1 and the second main part MP2 may include fourth trace lines TL4. Referring to FIGS. 2 and 4B together, the fourth trace lines TL4 may be electrically connected to the second ends of the second sensing electrodes SE2, respectively.

According to one or more embodiments of the present disclosure, an inspection line IL may include fourth inspection lines IL4 for inspecting the fourth trace lines TL4 included in each of the first main part MP1 and the second main part MP2.

The fourth inspection lines IL4 may include fifth sub-inspection lines SIL5 spaced apart from the fourth trace lines TL4 in the second direction DR2, and sixth sub-inspection lines SIL6 spaced apart from the fifth sub-inspection lines SIL5 in the second direction DR2. According to one or more embodiments of the present disclosure, the shape of the fourth trace lines TL4 may be the same as the shapes of the fifth sub-inspection lines SIL5 and the sixth sub-inspection lines SIL6. The distance/gap between the fourth trace lines TL4 and the fifth sub-inspection lines SIL5 may be equal to the distance/gap between the fifth sub-inspection lines SIL5 and the sixth sub-inspection lines SIL6.

In the same way as the method of inspecting the first trace lines TL1 for defects, the fourth trace lines TL4 may be inspected for defects through the fifth sub-inspection lines SIL5 and the sixth sub-inspection lines SIL6.

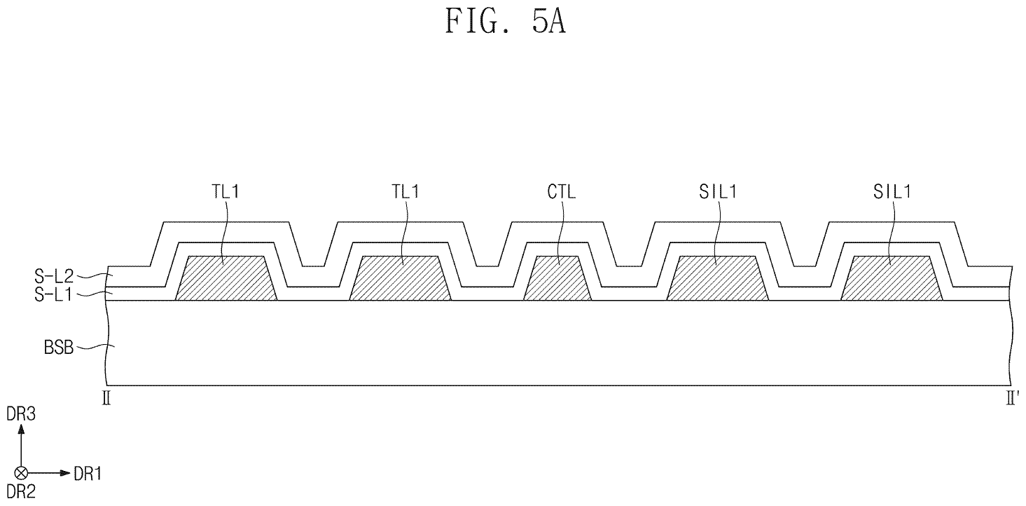

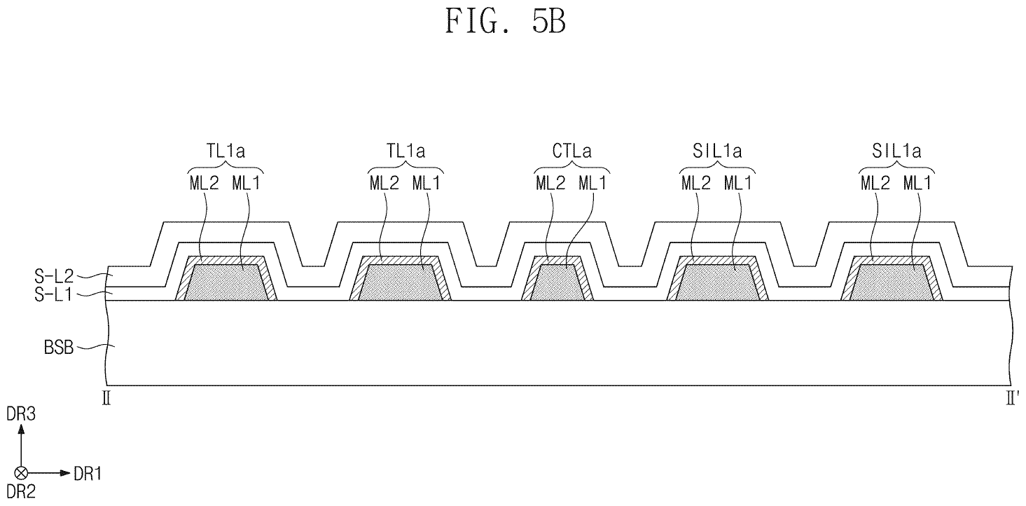

FIGS. 5A and 5B are sectional views taken along the line II-II′ of FIG. 4A.

Referring to FIG. 5A, the first trace lines TL1, the cutting line CTL, and the first sub-inspection lines SIL1 may be located on the base substrate BSB. For example, the first trace lines TL1, the cutting line CTL, and the first sub-inspection lines SIL1 may be located between the base substrate BSB and the first insulating layer S-L1.

According to one or more embodiments of the present disclosure, the first trace lines TL1, the cutting line CTL, and the first sub-inspection lines SIL1 may include the same material. For example, the first trace lines TL1, the cutting line CTL, and the first sub-inspection lines SIL1 may include the same material as the second sensing conductive layer SCL2 illustrated in FIG. 3B. That is, the first trace lines TL1, the cutting line CTL, the first sub-inspection lines SIL1, and the second sensing conductive layer SCL2 may be formed by the same process of performing patterning through a mask.

Referring to FIG. 5B, each of first trace lines TL1a, a cutting line CTLa, and first sub-inspection lines SIL1 a may include a first metal layer ML1, and a second metal layer ML2 located on the first metal layer ML1. The first metal layer ML1 has a higher electrical conductivity than the second metal layer ML2, and the second metal layer ML2 has a higher hardness than the first metal layer ML1.

The first metal layer ML1 may include a metal, such as aluminum (AI), copper (Cu), gold (Au), or silver (Ag). The first metal layer ML1 may include an alloy of the metals, or may include an alloy of the metals and a metal other than the metals.

The second metal layer ML2 may include a metal, such as molybdenum (Mo), nickel (Ni), chromium (Cr), or titanium (Ti). The second metal layer ML2 may include an alloy of the metals, or may include an alloy of the metals and a metal other than the metals. The thickness of the second metal layer ML2 may be greater than the thickness of the first metal layer ML1.

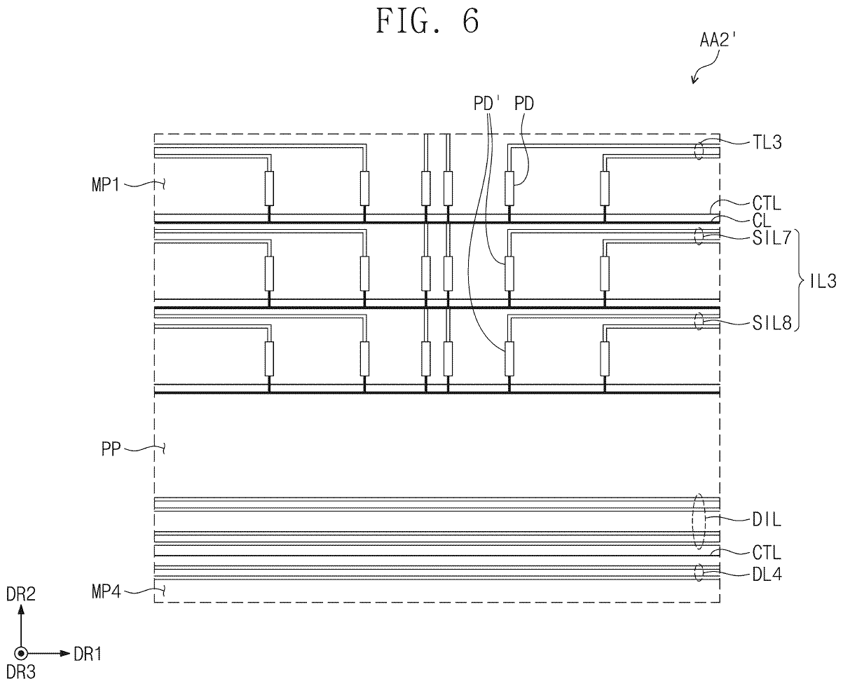

FIG. 6 is a plan view of a second area AA2′ of FIG. 1.

Referring to FIG. 6, the first main part MP1 may include the third trace lines TL3 and the pads PD to which the third trace lines TL3 are connected. In addition, the fourth main part MP4 may include fourth dummy lines DL4.

According to one or more embodiments of the present disclosure, the peripheral part PP may include third inspection lines IL3 and inspection pads PD′ for inspecting defects in the third trace lines TL3 and the pads PD to which the third trace lines TL3 are connected.

The third inspection lines IL3 may include seventh sub-inspection lines SIL7 spaced apart from the third trace lines TL3 in the direction opposite to the second direction DR2, and eighth sub-inspection lines SIL8 spaced apart from the seventh sub-inspection lines SIL7 in the direction opposite to the second direction DR2. The inspection pads PD′ may be electrically connected with the seventh sub-inspection lines SIL7 and the eighth sub-inspection lines SIL8.

According to one or more embodiments of the present disclosure, the shape of the third trace lines TL3 may be the same as the shapes of the seventh sub-inspection lines SIL7 and the eighth sub-inspection lines SIL8. The distance/gap between the third trace lines TL3 and the seventh sub-inspection lines SIL7 may be equal to the distance/gap between the seventh sub-inspection lines SIL7 and the eighth sub-inspection lines SIL8.

In the same way as the method of inspecting the first trace lines TL1 for defects, the third trace lines TL3 and the pads PD may be inspected for defects through the seventh sub-inspection lines SIL7, the eighth sub-inspection lines SIL8, and the inspection pads PD′.

A connecting line CL may be electrically connected with the third trace lines TL3, the seventh sub-inspection lines SIL7, and the eighth sub-inspection lines SIL8. For example, the connecting line CL may be electrically connected with the third trace lines TL3 through the pads PD, and may be electrically connected with the seventh sub-inspection lines SIL7 and the eighth sub-inspection lines SIL8 through the inspection pads PD′. Although the third trace lines TL3 are electrically connected with the connecting line CL, the third trace lines TL3 may be electrically disconnected from the connecting lines CL after being cut through the cutting line CL in a later process.

The peripheral part PP of the present disclosure may include dummy inspection lines DIL corresponding to the fourth dummy lines DL4 included in the fourth main part MP4. The dummy inspection lines DIL may have the same shape as the fourth dummy lines DL4. For example, the dummy inspection lines DIL may extend in the first direction DR1, and may be arranged in the second direction DR2.

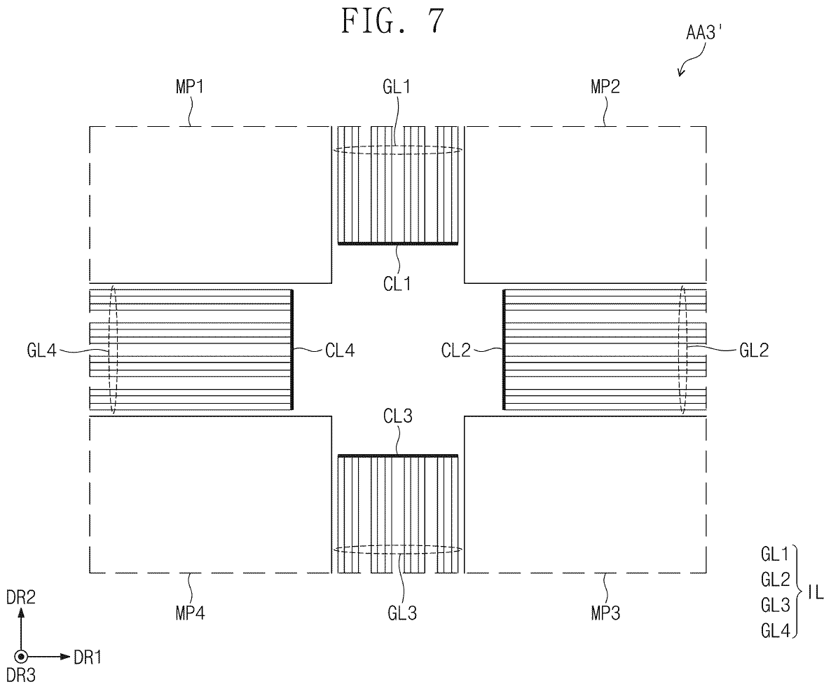

FIG. 7 is a plan view of a third area AA3′ of FIG. 1.

Referring to FIG. 7, inspection lines IL may include first to fourth group lines GL1, GL2, GL3, and GL4. The first group line GL1 may be defined as inspection lines IL located between the first main part MP1 and the second main part MP2. The second group line GL2 may be defined as inspection lines IL located between the second main part MP2 and the third main part MP3. The third group line GL3 may be defined as inspection lines IL located between the third main part MP3 and the fourth main part MP4. The fourth group line GL4 may be defined as inspection lines IL located between the first main part MP1 and the fourth main part MP4.

The first group line GL1 may be electrically connected by a first connecting line CL1, the second group line GL2 may be electrically connected by a second connecting line CL2, the third group line GL3 may be electrically connected by a third connecting line CL3, and the fourth group line GL4 may be electrically connected by a fourth connecting line CL4. In one or more embodiments, an intermediate line electrically connecting the first to fourth connecting lines CL1, CL2, CL3, and CL4 may be additionally located. The intermediate line may be located between the first to fourth connecting lines CL1, CL2, CL3, and CL4 and may be electrically connected with the first to fourth connecting lines CL1, CL2, CL3, and CL4.

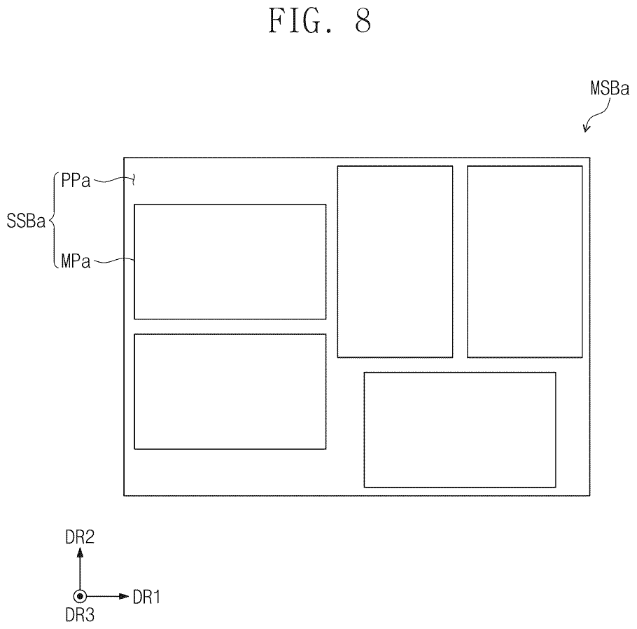

FIG. 8 is a plan view of a mother substrate for a sensor according to one or more embodiments of the present disclosure. The mother substrate MSBa may include the base substrate BSB (refer to FIG. 3B), and a sensor substrate SSBa located on the base substrate BSB. In FIG. 8, only the sensor substrate SSBa located on the base substrate BSB is illustrated.

Referring to FIG. 8, the sensor substrate SSBa may include a main part Mpa, and a peripheral part PPa surrounding the main part MPa. The main part MPa may include a plurality of main parts. As illustrated in FIG. 8, five main parts MPa may be provided. However, the present disclosure is not limited thereto, and the number of main parts MPa may vary depending on the size of the sensor substrate SSBa and the size of the main part MPa.

FIG. 9A is a perspective view of an electronic device according to one or more embodiments of the present disclosure. FIG. 9B is an exploded perspective view of the electronic device illustrated in FIG. 9A according to one or more embodiments of the present disclosure.

The electronic device ED may be a device that is activated in response to an electrical signal and that displays an image. The electronic device ED may include various embodiments that provide images to various users. For example, the electronic device ED may be a small or medium-sized device, such as a monitor, a mobile phone, a tablet computer, a car navigation unit, or a game machine, as well as a large device, such as a television or a billboard. The embodiments of the electronic device ED are illustrative, and the electronic device ED is not limited to any embodiments as long as it does not deviate from the spirit and scope of the present disclosure.

Referring to FIG. 9A, the electronic device ED may have a rectangular shape with long sides extending in the first direction DR1 and short sides extending in the second direction DR2 crossing the first direction DR1. However, without being limited thereto, the electronic device ED may have various shapes, such as a circular shape, a polygonal shape, and the like.

The electronic device ED may display an image IM in a third direction DR3 through a display surface IS parallel to a plane defined by the first direction DR1 and the second direction DR2. The third direction DR3 may be substantially parallel to the normal direction of the display surface IS. The display surface IS, on which the image IM is displayed, may correspond to the front surface of the electronic device ED. The image IM may include a still image as well as a dynamic image. FIG. 9A illustrates the electronic device ED having the flat display surface IS. However, the display surface IS of the electronic device ED is not limited thereto and may have a curved shape or a three-dimensional shape.

The electronic device ED may be a flexible electronic device. The term “flexible” used herein may mean a property of being bent and may include everything from a structure capable of being fully folded to a structure capable of being bent to a level of several nanometers. For example, the electronic device ED that is flexible may be a curved device or a foldable device. Without being limited thereto, the electronic device ED may be a rigid device.

The display surface IS of the electronic device ED may include a display part D-DA and a non-display part D-NDA. The display part D-DA may be a part where the image IM is displayed on the front surface of the electronic device ED, and a user may visually recognize the image IM through the display part D-DA. Although the display part D-DA having a rectangular shape is illustrated, the display part D-DA may have various shapes depending on the design.

The non-display part D-NDA may be a part where the image IM is not displayed on the front surface of the electronic device ED. The non-display part D-NDA may be a part that has a corresponding color, and that blocks light. The non-display part D-NDA may be adjacent to the display part D-DA. For example, the non-display part D-NDA may be located outside the display part D-DA, and may surround the display part D-DA (e.g., in plan view). However, this is illustrative, and the non-display part D-NDA may be adjacent to only one side of the display part D-DA or may be located on a side surface rather than the front surface of the electronic device ED. Without being limited thereto, the non-display part D-NDA may be omitted.

The electronic device ED of one or more embodiments may sense an external input applied from the outside. The external input may have various forms, such as pressure, temperature, light, and/or the like that are provided from the outside. The external input may include not only an input contacting the electronic device ED (e.g., contact by a hand of the user or a pen), but also an input (e.g., hovering) applied in proximity to the electronic device ED.

Referring to FIG. 9B, the electronic device ED may include a window WM, the display module DM, and an outer case HAU. The display module DM may include a display panel DP and the input sensor ISP located on the display panel DP.

The window WM and the outer case HAU may be coupled to form the exterior of the electronic device ED, and may provide an inner space in which components of the electronic device ED, such as the display module DM, are accommodated.

The window WM may be located on the display module DM. The window WM may protect the display module DM from external impact. The front surface of the window WM may correspond to the above-described display surface IS of the electronic device ED. The front surface of the window WM may include a transmissive area TA and a bezel area BA.

The transmissive area TA of the window WM may be an optically clear area. The window WM may transmit, through the transmissive area TA, an image provided by the display module DM, and the user may visually recognize the corresponding image. The transmissive area TA may correspond to the display part D-DA (refer to FIG. 9A) of the electronic device ED.

The window WM may include an optically clear insulating material. For example, the window WM may include glass, sapphire, or plastic. The window WM may have a single-layer structure or a multi-layer structure. The window WM may further include functional layers, such as an anti-fingerprint layer, a phase control layer, and a hard coating layer, which are located on an optically clear substrate.

The bezel area BA of the window WM may be an area where a material having a corresponding color is deposited, coated, or printed on the optically clear substrate. The bezel area BA of the window WM may reduce or prevent external visibility of a component of the display module DM overlapping the bezel area BA. The bezel area BA may correspond to the non-display part D-NDA (refer to FIG. 9A) of the electronic device ED.

The display module DM may be located between the window WM and the outer case HAU. The display module DM may display an image in response to an electrical signal. The display module DM may include a display area DA, and a non-display area NDA adjacent to the display area DA.

The display area DA may be an area activated in response to an electrical signal. The display area DA may be an area that outputs an image provided from the display module DM. The display area DA of the display module DM may correspond to the above-described transmissive area TA. An image generated in the display area DA may be visible from the outside through the transmissive area TA.

The non-display area NDA may be adjacent to the display area DA. For example, the non-display area NDA may surround the display area DA. However, without being limited thereto, the non-display area NDA may be defined in various shapes. The non-display area NDA may be an area where a drive circuit or drive wiring for driving elements located in the display area DA, various types of signal lines that provide electrical signals, and pads are located. The non-display area NDA of the display module DM may correspond to the bezel area BA of the window WM, and the bezel area BA may reduce or prevent external visibility of components of the display module DM located in the non-display area NDA.

The display panel DP according to one or more embodiments may be an emissive display panel, but is not particularly limited thereto. For example, the display panel DP may be an organic light-emitting display panel, an inorganic light-emitting display panel, or a quantum-dot light-emitting display panel. An emissive layer of the organic light-emitting display panel may include an organic luminescent material, and an emissive layer of the inorganic light-emitting display panel may include an inorganic luminescent material. An emissive layer of the quantum-dot light-emitting display panel may include quantum dots and quantum rods. Hereinafter, it will be exemplified that the display panel DP is an organic light-emitting display panel.

The input sensor ISP may be located on the display panel DP. The input sensor ISP may obtain information about the coordinates of an external input applied from outside the electronic device ED. The input sensor ISP may be driven by various methods, such as a capacitive-detecting method, a resistive-detecting method, an infrared-detecting method, and a pressure-detecting method, but is not limited to any one method. The input sensor ISP may be directly located on the display panel DP through a continuous process. Without being limited thereto, the input sensor ISP may be manufactured separately from the display panel DP, and may be attached to the display panel DP by an adhesive layer. The input sensor ISP may correspond to the main part MP described with reference to FIG. 1.

The display module DM of the present disclosure may further include a light control member. The light control member may convert the wavelength of light provided from the display panel DP, or may selectively transmit light provided from the display panel DP. In addition, the light control member may reduce or prevent the reflection of external light incident from outside the electronic device ED.

The outer case HAU may be located under the display module DM and may accommodate the display module DM. The outer case HAU may protect the display module DM by absorbing impact applied to the display module DM from the outside, and by reducing or preventing infiltration of foreign matter and/or moisture into the display module DM. The outer case HAU of one or more embodiments may be implemented in a form in which a plurality of receiving members are coupled.

The electronic device ED may further include an electronic module including various functional modules for operating the display module DM, a power supply module that supplies power required for the electronic device ED, and a bracket coupled with the display module DM and/or the outer case HAU to divide the inner space of the electronic device ED.

The mother substrate for the sensor according to the present disclosure may include the main parts corresponding to the input sensor, and the peripheral part surrounding the main parts (e.g., in plan view). The peripheral part may include the inspection lines for inspecting the trace lines included in the main parts. The trace lines may be easily inspected for defects through the inspection lines, and thus, the reliability of the input sensor to be formed through the main part may be improved.

While the present disclosure has been described with reference to embodiments thereof, it will be apparent to those of ordinary skill in the art that various changes and modifications may be made thereto without departing from the spirit and scope of the present disclosure as set forth in the following claims, with functional equivalents thereof to be included therein.

What is claimed is:

1. A mother substrate for a sensor, the mother substrate comprising:
a base substrate; and
a sensor substrate above the base substrate, and comprising:
a main part comprising:
a sensing area;
a non-sensing area surrounding the sensing area in plan view;
a sensing electrode in the sensing area; and
a trace line in the non-sensing area, and electrically connected with the sensing electrode; and
a peripheral part surrounding the main part in plan view, and comprising an inspection line spaced apart from the trace line and having a same shape as the trace line.

2. The mother substrate of claim 1, wherein the inspection line comprises:
a first sub-inspection line spaced apart from the trace line in a first direction; and
a second sub-inspection line spaced apart from the first sub-inspection line in the first direction.

3. The mother substrate of claim 2, wherein a distance between the trace line and the first sub-inspection line is substantially equal to a distance between the first sub-inspection line and the second sub-inspection line.

4. The mother substrate of claim 1, wherein the trace line comprises:
a first trace line connected to one end of the sensing electrode; and
a second trace line connected to an opposite end of the sensing electrode that is opposite the one end of the sensing electrode.

5. The mother substrate of claim 4, wherein the inspection line comprises:
a first inspection line spaced apart from the first trace line in a first direction; and
a second inspection line spaced apart from the second trace line in a direction opposite to the first direction.

6. The mother substrate of claim 5, wherein the main part further comprises a first main part and a second main part aligned in the first direction, and
wherein a virtual line crossing a center between the first main part and the second main part is defined between the first main part and the second main part.

7. The mother substrate of claim 6, wherein the first inspection line corresponding to the first trace line in the first main part, and the second inspection line corresponding to the second trace line in the second main part, have symmetrical shapes with respect to the virtual line.

8. The mother substrate of claim 1, wherein the main part has a quadrangular shape comprising first to fourth surfaces, and
wherein the inspection line comprises first to fourth inspection lines respectively corresponding to the first to fourth surfaces.

9. The mother substrate of claim 8, wherein the peripheral part further comprises a connecting line electrically connecting the first to fourth inspection lines.

10. The mother substrate of claim 9, wherein the connecting line is configured to receive a ground voltage.

11. The mother substrate of claim 1, wherein the sensor substrate further comprises a cutting line for dividing the main part from the peripheral part.

12. The mother substrate of claim 11, wherein the cutting line is between the trace line and the inspection line.

13. The mother substrate of claim 11, wherein the cutting line comprises a metal layer, and an insulating layer above the metal layer.

14. The mother substrate of claim 1, wherein the trace line and the inspection line comprise a first metal layer, and a second metal layer above the first metal layer.

15. The mother substrate of claim 14, wherein the trace line and the inspection line further comprise an anti-oxidation film between the first metal layer and the second metal layer.

16. A mother substrate for a sensor, the mother substrate comprising:
a base substrate; and
a sensor substrate above the base substrate, and comprising:
a main part comprising:
a sensing area;
a non-sensing area configured to surround the sensing area; and
a signal line in the non-sensing area; and
a peripheral part surrounding the main part in plan view, and comprising an inspection line spaced apart from the signal line, having a same shape as the signal line, and comprising:
a first sub-inspection line spaced apart from the signal line by a first distance; and
a second sub-inspection line spaced apart from the first sub-inspection line by the first distance in a direction opposite to a direction in which the signal line is located.

17. The mother substrate of claim 16, wherein the main part further comprises a sensing electrode in the sensing area, and
wherein the signal line comprises:
a first signal line connected to one end of the sensing electrode; and
a second signal line connected to an opposite end of the sensing electrode that is opposite the one end of the sensing electrode.

18. The mother substrate of claim 17, wherein the first sub-inspection line and the second sub-inspection line correspond to the first signal line, and
wherein the inspection line further comprises:
a third sub-inspection line spaced apart from the second signal line by the first distance; and
a fourth sub-inspection line spaced apart from the third sub-inspection line by the first distance in a direction opposite to a direction in which the second signal line is located.

19. The mother substrate of claim 18, wherein the main part further comprises a first main part and a second main part that are aligned, and
wherein a virtual line crossing a center between the first main part and the second main part is defined between the first main part and the second main part.

20. The mother substrate of claim 19, wherein the first sub-inspection line corresponding to the first signal line in the first main part, and the third sub-inspection line corresponding to the second signal line in the second main part, have symmetrical shapes with respect to the virtual line, and
wherein the second sub-inspection line corresponding to the first signal line in the first main part, and the fourth sub-inspection line corresponding to the second signal line in the second main part, have symmetrical shapes with respect to the line.
